(19) United States
(12) Patent Application Publication
(10) Pub. No.: US 2014/0023987 A1
(43) Pub. Date: Jan. 23, 2014

(54) ADJUSTABLE SUCTION APPARATUS FOR DENTAL ASPIRATOR

(71) Applicant: Bryan E. Cardon, Oklahoma City, OK (US)

(72) Inventor: Bryan E. Cardon, Oklahoma City, OK (US)

(21) Appl. No.: 13/555,072

(22) Filed: Jul. 20, 2012

(51) Int. Cl. A61C 17/12

(52) U.S. Cl. 433/95; 433/215

(57) ABSTRACT

An aspirator tip for a dental aspirator comprising: an elongated hollow tube comprising a first end and a second end, the first end configured to connect to a dental aspirator unit to provide suction to the second end of the elongated hollow tube, the second end configured to be inserted into an oral cavity of a patient, an opening in a portion of the elongated hollow tube between the first end and the second end of the elongated hollow tube, a gate configured to be inserted into the opening, and an actuator configured for actuation by a single digit (e.g., finger or thumb) to insert the gate into the opening to at least partially block an airway through the elongated hollow tube.

### TECHNICAL FIELD

The present invention relates generally to dental apparatus and more particularly, to a dental aspirator tip configured to be connected to a dental aspirator and to change the amount of suction applied through the dental aspirator tip.

### BACKGROUND OF RELATED ART

Dental aspirator devices are routinely used by dentists to remove debris from a patient's mouth during dental procedures. A high suction aspirator, commonly referred to as a high volume evacuator (HVE), is normally used to quickly remove most of the debris that might accumulate in a patient's mouth during oral surgery. A low suction aspirator is also needed to remove the remaining debris as well as saliva and rinse water. Typically, both high and low suction aspirators are utilized repeatedly during a dental procedure, in order to thoroughly clean a patient's mouth. Thus, a dentist must frequently switch from a high suction aspirator to a low suction aspirator. This can be a cumbersome procedure in which one device must be turned off and handed to an assistant or placed in a holder before picking up the other device and turning it on.

A disposable tip is needed for both high suction and low suction aspirators. Different sized and shaped tips may be needed for different procedures and patients. When two aspirators are used, two different disposable tips are needed, thereby increasing the need for more available tips, as well as the cost and time needed for a dental procedure.

In United States Patent Application Publication US 2005/0014107 of Culver (hereinafter “Culver”), a dental aspirator with a high suction line and a low suction line is disclosed. Switches are provided for a dentist to connect to the high suction line or the low suction line, as needed. The two separate suction lines and switch appear to make the dental aspirator of Culver rather complex and cumbersome. As seen in FIG. 3 of Culver, separate switches 56′ and 56″ are needed to switch separate valves 60′ and 60″ by way of linkages 58′ and 58″ between the switches 56′ and 56″ and the valves 60′ and 60″.

Variable suction aspirator devices have been developed in which adjustable mechanisms are provided to vary the amount of suction as needed. U.S. Pat. No. 7,802,574 to Schulz (hereinafter “Schulz”) provides a port and valve device for a dentist to incrementally change the amount of suction by applying pressure to a valve. U.S. Pat. No. 5,076,787 to Overmyer (hereinafter “Overmyer”) uses an inner valve tube with wall holes and a slidable outer barrel to adjust the amount of suction applied. Such devices are infinitely variable, making it difficult for a dentist to quickly select the precise amount of suction desired or needed. Moreover, the complexity of variable valves and barrels increases the likelihood of a malfunction and the difficulty of cleaning the mechanisms after each use.

### SUMMARY

A tip apparatus for a dental aspirator may comprise an elongated hollow tube comprising a first end and a second end, the first end configured to connect to a dental aspirator unit to provide suction to the second end of the elongated hollow tube, the second end adapted to be inserted into an oral cavity of a patient. The tip apparatus may also include an opening in a portion of the elongated hollow tube between the first end and the second end of the elongated hollow tube, and a gate configured to be inserted into the opening. The tip apparatus may also include an actuator adapted for actuation by a single digit to insert the gate into the opening to at least partially block the airway of the elongated hollow tube. Together, the gate and the actuator are referred to as a “gate unit.”

In various embodiments, a tip apparatus may be configured for attachment to a high volume evacuator (HVE) dental unit. The tip apparatus may comprise a dental aspirator tip, which may be configured to be affixed or otherwise coupled to the high volume evacuator dental unit to apply suction to an oral cavity of a patient. In addition to the dental aspirator tip, the tip apparatus may include a gate, which may be configured to change the suction applied to the oral cavity by or to a preselected amount, and an actuator associated with the gate, which may be operated with a single digit (e.g., finger or thumb) of a person grasping a portion of the dental aspirator unit to move the gate and thereby actuate the change of the applied suction. As used hereinafter, the “aspirator tip” may be used interchangeably with “tip apparatus,” or it may refer to the dental aspirator tip portion of the tip apparatus.

Also disclosed is a process for applying a variable suction to the mouth of a patient by way of an aspirator tip connected to an aspirator device having a constant amount of suction. The process may comprise partially blocking the suction being applied by the aspirator device to the aspirator tip by depressing an actuator using a single digit of a person grasping the aspirator tip.

Other aspects, as well as features and advantages of various aspects, of the disclosed subject matter will become apparent to those of ordinary skill in the art through consideration of the ensuing description, the accompanying drawings and the appended claims.

### BRIEF DESCRIPTION OF THE DRAWINGS

FIG. 1 is a perspective view of an embodiment of aspirator tip configured to be connected to an aspirator unit.

FIG. 2 is a perspective view of the aspirator tip shown in FIG. 1 attached to an aspirator unit.

FIG. 3 is a side view of the aspirator tip shown in FIG. 1 with a gate unit in a first position.

FIG. 4 is another perspective view of the aspirator tip shown in FIG. 1.

FIG. 5 is a top view of the aspirator tip shown in FIG. 1 with the gate unit in the first position.

FIG. 6 is a partial cross section of the aspirator tip shown in FIG. 1 with the gate unit in the first position.

FIG. 7 is a side view of the aspirator tip shown in FIG. 1 with the gate unit in a second position;

FIG. 8 is a partial cross section of the aspirator tip shown in FIG. 7 with the gate unit in the second position.

FIG. 9 is a side view of the aspirator tip shown in FIG. 1 with the gate unit in a third position.

FIG. 10 is a top view of the aspirator tip shown in FIG. 9 with the gate unit in the third position.

FIG. 11 is a partial cross section of the aspirator tip shown in FIGS. 9 and 10 with the gate unit in the third position.

### DETAILED DESCRIPTION

The disclosed embodiments provide a tip for a dental aspirator, or HVE, to enable a dentist to quickly and precisely change the amount of suction being applied through the tip. An opening at an intermediate location along a length of the tip is configured to receive a flexible gate, which can be selectively inserted into the opening and across a channel extending through the length of the tip to regulate the suction being applied at an end of the tip.

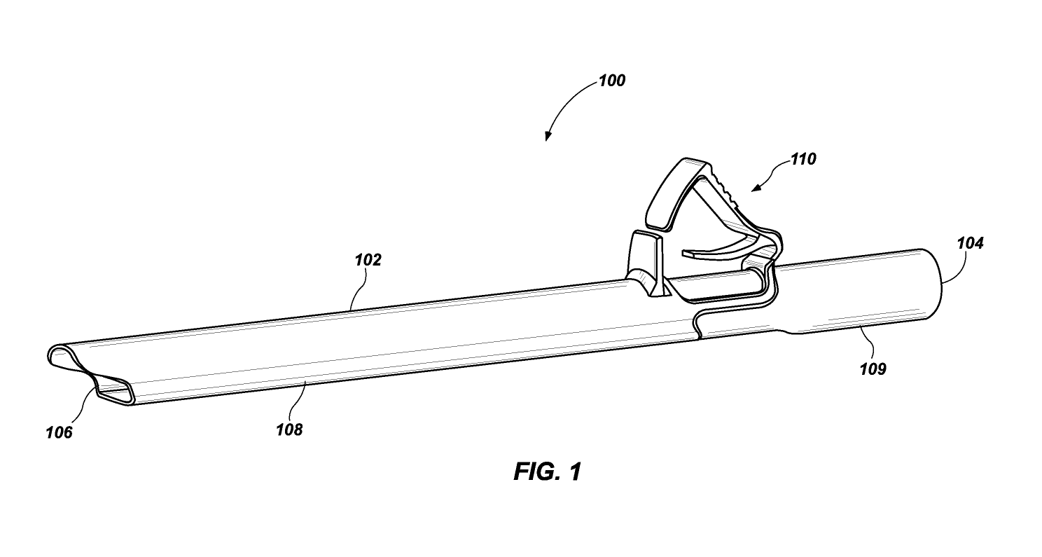

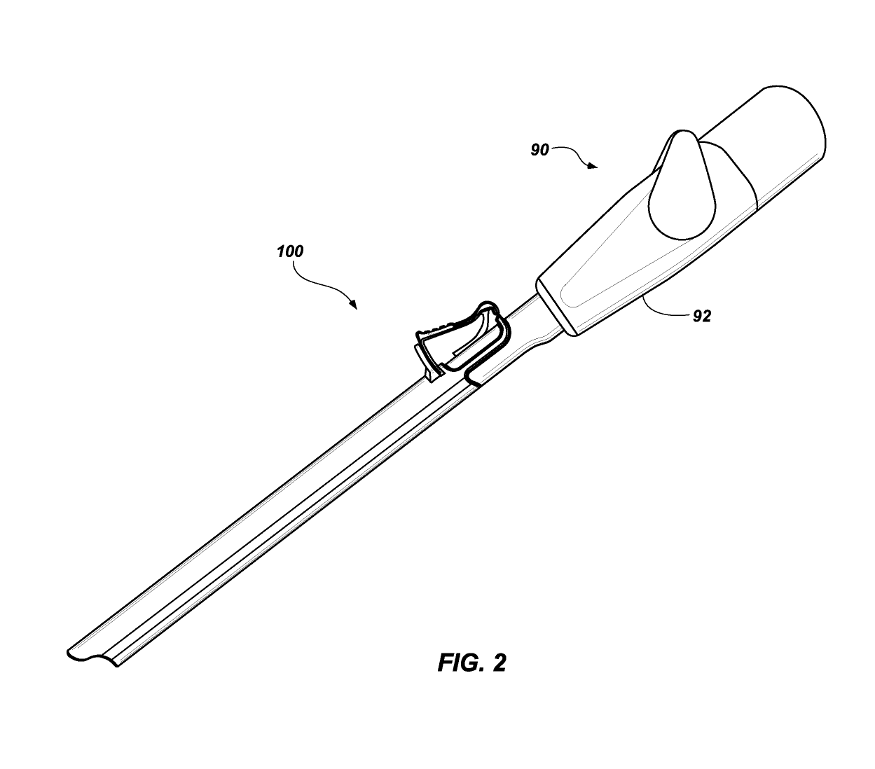

Referring to FIG. 1, an embodiment of a tip, which is referred to herein as an “aspirator tip” 100, is shown in the form of a longitudinal tube 102 having a first end 104 for attaching to a conventional HVE unit. The aspirator tip 100 is one example of a variable suction dental device. FIG. 2 shows an example of an aspirator tip 100 attached directly to an HVE valve 92 of an HVE unit 90. The HVE unit 90 is routinely used to remove debris from the mouth of a patient during dental procedures (e.g., drilling, filling, surgery, etc.).

The aspirator tip 100 may be disposable for hygienic purposes. In some embodiments, the aspirator tip 100 and many of its parts may be formed from a suitable plastic material.

Returning to FIG. 1, a tip end 106 (also referred to as a “second end” to differentiate the tip end 106 from the first end 104) of the tube 102 may be beveled to facilitate its insertion into the oral cavity of a patient. The tip end 106 may have various shapes and sizes depending on the size of the patient's mouth patient and the type of procedure being performed.

On top of the tube 102, near the first end 104, is a gate unit 110. The gate unit 110 is utilized to regulate the amount of suction being applied by the aspirator tip 100 to the mouth of the patient. The tube 102 may have an outer sleeve 108 that extends from the tip end 106 to the gate unit 110. The tube 102 may cover an elongated hollow tube 109 that forms a channel, or “hollow airway,” (not shown) for applying suction along the length of the tube 102.

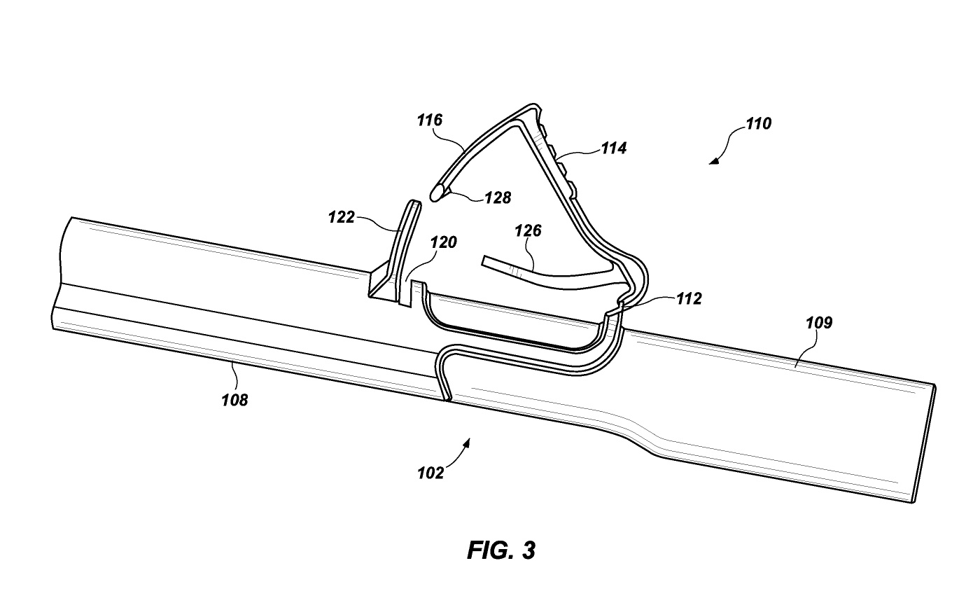

Referring to FIG. 3, an embodiment of the gate unit 110 is shown in more detail. The gate unit 110 may include a hinge 112. In one embodiment, and as shown in FIG. 3, the hinge 112 may comprise a living hinge 112 that is formed integrally with the outer sleeve 108 of the tube 102, enabling the gate unit 110 to pivot relative to the tube 102. Other suitable constructions for a hinge 112 may also be used. The gate unit 110 may also include an actuator 114 adapted for actuation by a single digit (e.g., finger or thumb). The actuator 114 and the hinge 112 may integral with one another. A gate 116 may be located at an opposite end of the actuator 114. The gate 116 may extend in a different direction from the actuator 114, toward the tube 102. In some embodiments, the actuator 114 and the gate 116 may be integral with each other. When actuated, the actuator 114 may cause a gate 116 to at least partially block the airway through the tube 102, or it may at least partially remove the gate 116 from the airway to further open the airway. In one embodiment, the actuator 114 is a thumb pad. While FIG. 3 shows a thumb pad embodiment of actuator 114, other suitable embodiments of actuators 114 may also be used. While FIG. 3 shows a particular embodiment of gate 116, other varieties of blocking elements or devices may also be used to diminish suction by a predetermined amount.

An opening is formed in an intermediate portion of the tube 102 between the first end 104 and the tip end 106. In the embodiment shown in FIG. 3, the opening is a slot 120 formed in the top of the tube 102. While FIG. 3 illustrates use of a slot 120, other suitable configurations for an opening may also be used. The slot 120 provides access to the airway extending through the tube 102, and is configured to receive the gate 116. A small lock nub 128, which may be located at or near an end of the gate 116, may inhibit complete removal of the gate 116 from the slot 120. The lock nub 128 may be wedge shaped so that that gate 116 may be held into position at the mouth of the slot 120.

In addition to the gate 116, its associated actuator 114, and the hinge 112, the gate unit 110 may also include a guide member 122 adjacent to the slot 120, which extends outwardly from the sleeve 108. The guide member 122 may align an end of the gate 116 with the slot 120 as the actuator 114 is depressed, which may ensure proper motion of the gate 116 relative to the slot 120. The guide member 122 may also prevent an operator from contacting the gate 116, which may prevent contamination of the gate 116 and prevent protective gloves or clothing from being caught in the slot 120.

A spring member 126 may extend a lower surface of the actuator 114, toward the tube 102 to bias the actuator 114 and the gate 116 toward an open position (i.e., away from the tube 102), in which the gate 116 is positioned to enable maximum flow through the airway. While FIG. 3 shows the use of the spring member 126, other suitable biasing elements may also be used.

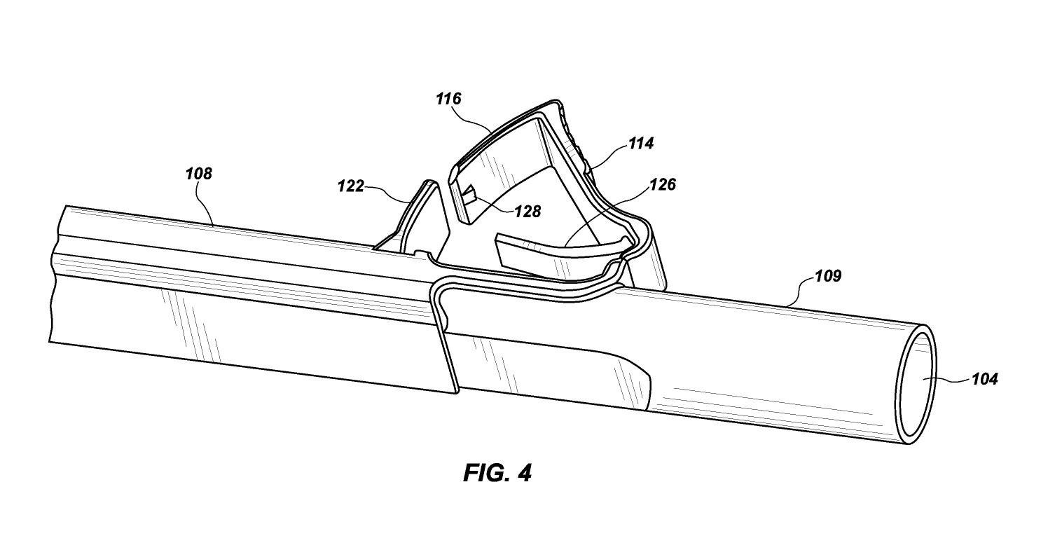

Looking now at FIG. 4, another perspective view of the aspirator tip 100 is shown, in which the shapes of some of the components of the aspirator tip 100 can be seen more clearly. The gate 116 may be generally rectangular in shape, but curved somewhat to enable its pivotal movement into and out of the slot 120. The guide member 122 may also be essentially rectangular.

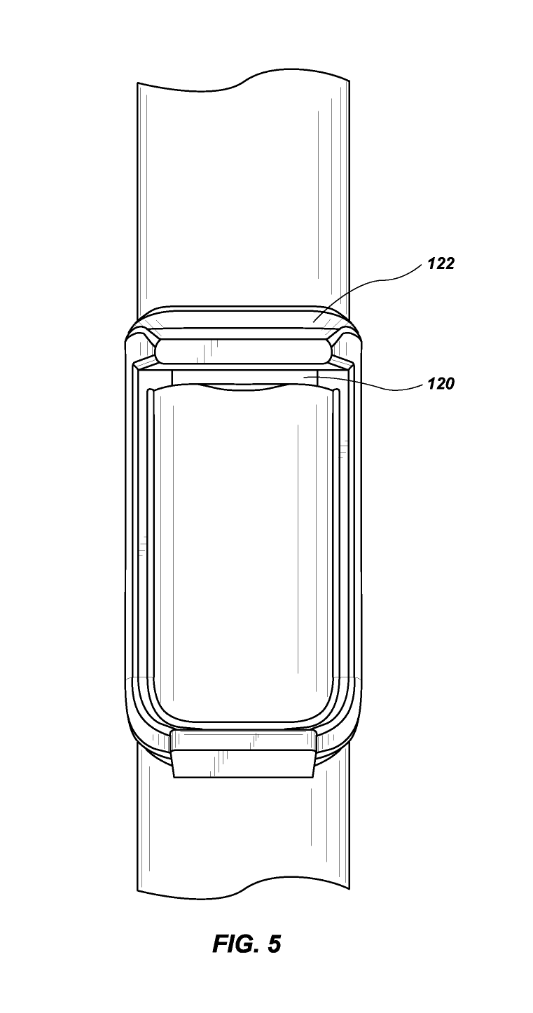

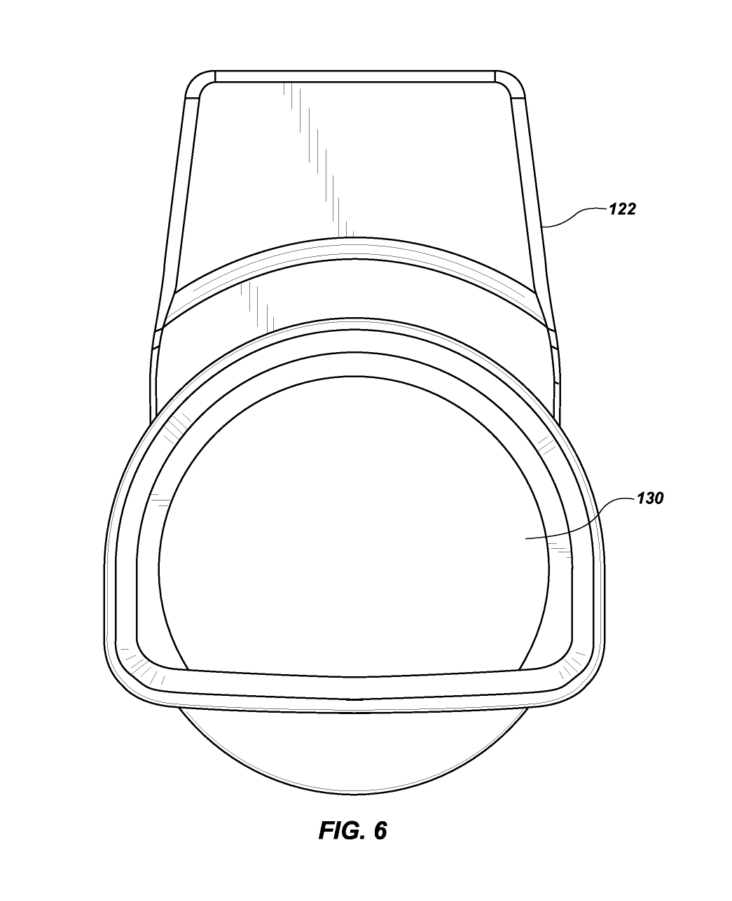

FIG. 5 is a partial top view of the aspirator tip 110 showing the configuration of the slot 120. In the depicted embodiment, the slot 120 extends across most of the width of the tube 102, directly behind guide member 122. FIG. 6 is a partial cross section taken through the aspirator tip 110 at the slot 120. Thus, FIG. 6 shows an embodiment of the cross-sectional shape of the airway 130 through the tube 102. The shape of the depicted embodiment of guide member 122 is also shown more clearly.

In one embodiment, the slot 120 is about 1 mm wide (along the z-axis illustrated in FIG. 5) and about 10 mm long (along the x-axis illustrated in FIG. 5). In such an embodiment, the gate 116 may be slightly less than about 1 mm thick, about 10 mm wide (along the x-axis illustrated in FIG. 3), and about 14 mm long (along the y-axis illustrated in FIG. 3), so that the gate 116 may be inserted through the slot 120 to a depth of about 14 mm into the airway 130 of the tube 102.

In operation, there are three designated positions for the gate unit 110. FIGS. 1-4 show the gate unit 110 in a first position, referred to as an “open non-inserted” position. In the open position of gate unit 110, the gate 116 is entirely disengaged from the slot 120. In this position the airway 130 is totally unobstructed, so that a high volume of suction is provided to the beveled end 106 of tip 100 for high-volume evacuation of debris in a patient's mouth.

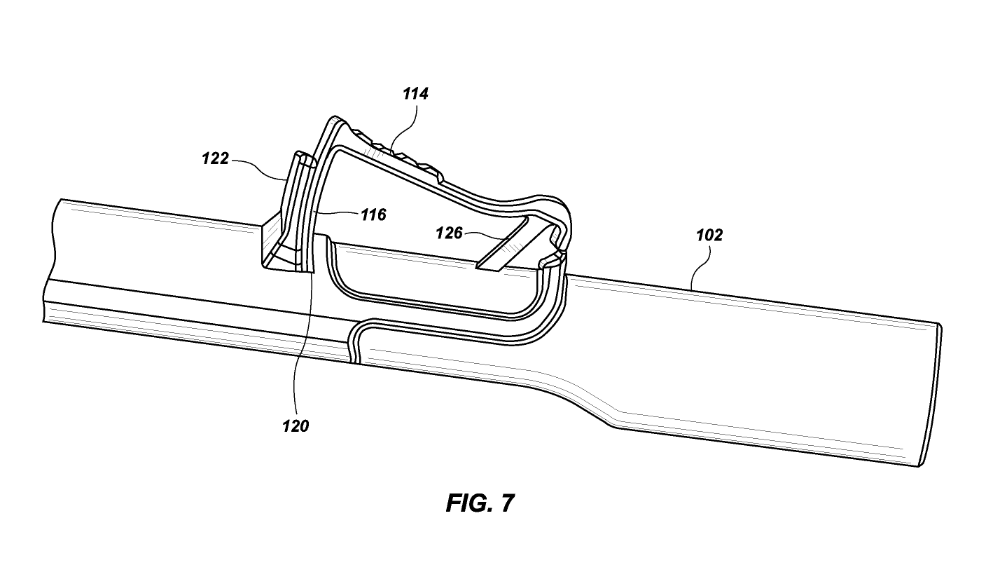

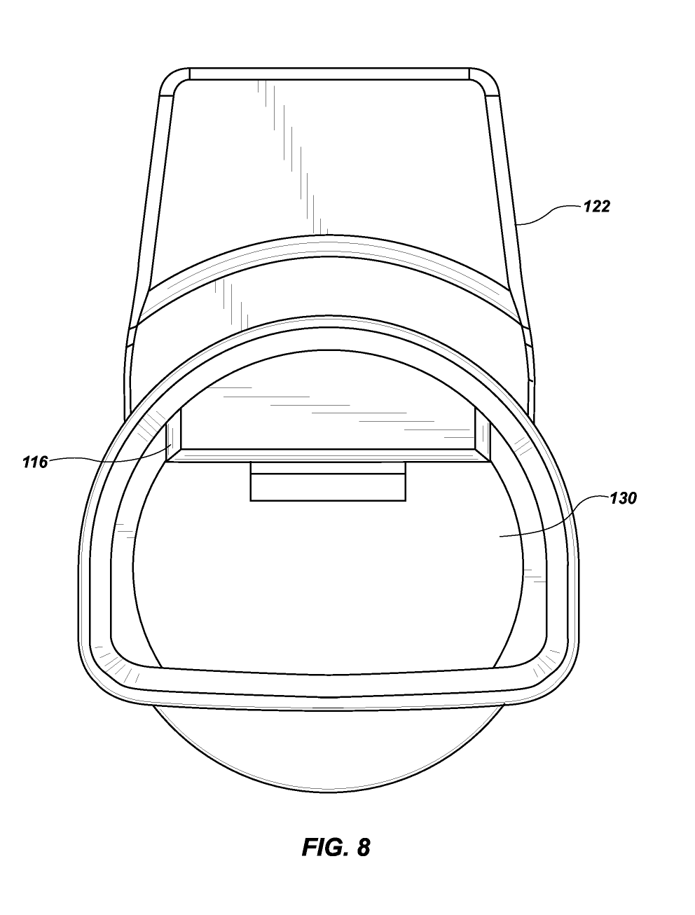

Looking next at FIG. 7, a second position of gate unit 110 is shown, referred to as the “open inserted” position. In this position, sufficient pressure has been applied to the actuator 114 to cause the gate 116 to be slightly inserted into the slot 120. In this position, the lock nub 128 (not shown here) disposed at or near the end of the gate 116 has been inserted into the slot 120. The spring member 126 presses against the surface of the tube 102, while the lock nub 128 prevents the gate 116 from being totally removed from the slot. The resulting tension holds the gate 116 in place, where it only partially obstructs the airway 130, as seen in FIG. 8. When the gate unit 110 in the open inserted position, the gate 116 does not block the airway 130 enough to significantly reduce high-volume evacuation through the tube 102. However, the gate 116 is in a ready position for complete insertion into the tube 102

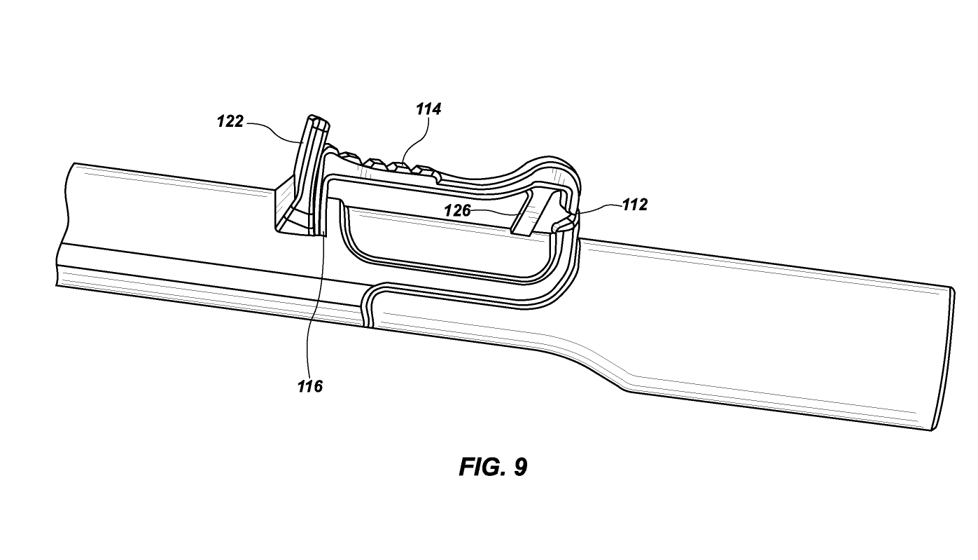

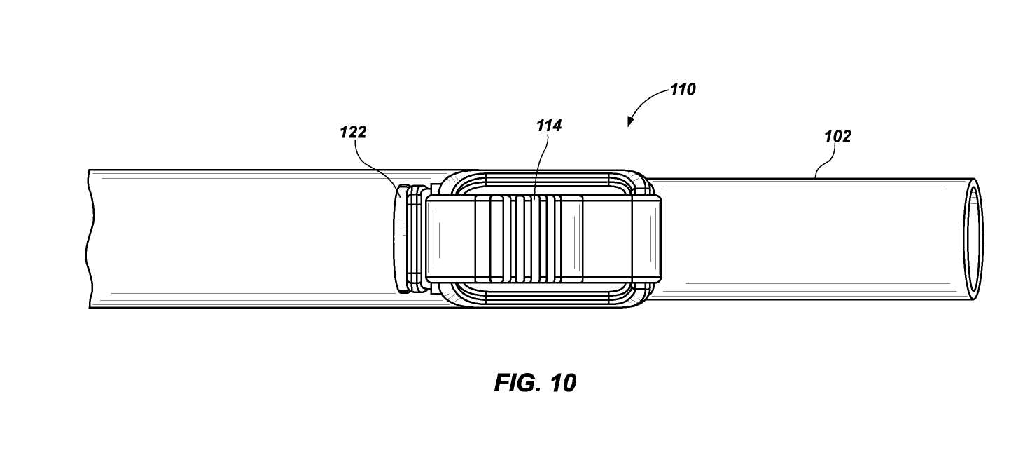

Referring now to FIGS. 9 and 10, a third position of gate unit 110, referred to as the “closed inserted” position, is shown. To place the gate unit 110 in the closed inserted position, sufficient pressure has been exerted on the actuator 114 for it to pivot about the hinge 112 and urge the gate 116 through the slot 120 until it has been inserted as far as possible into the slot 120.

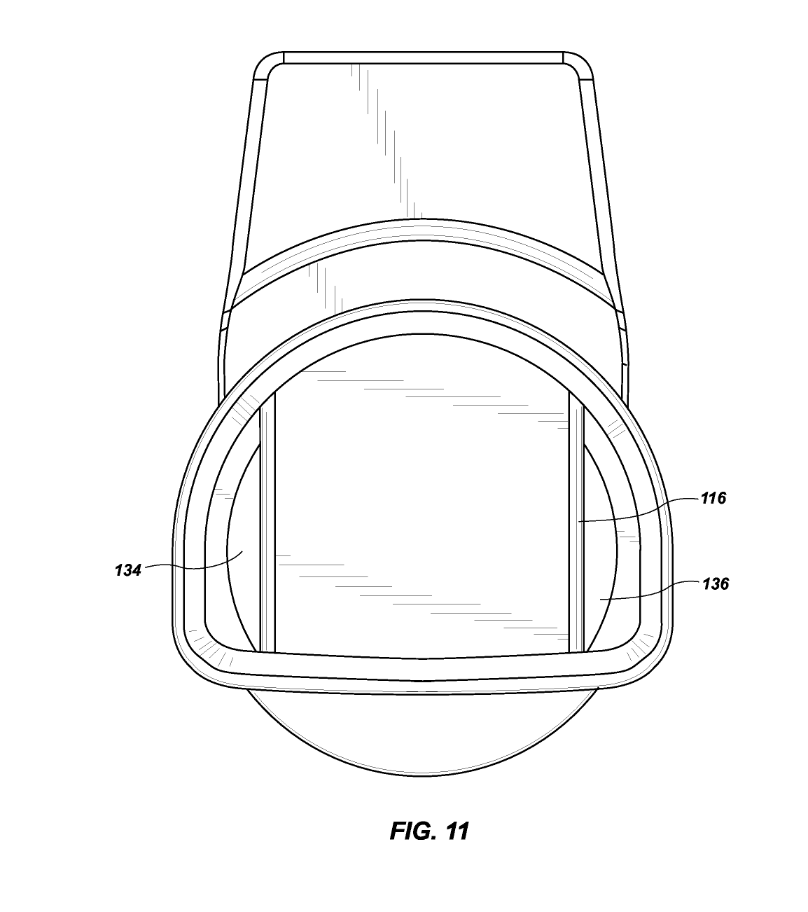

FIG. 11 shows a partial cross section of FIG. 9 taken at the slot 120. The gate 116 can be seen blocking off most of the airway 130 through the tube 102. Portions 134 and 136 of the airway 130 are the only portions of the airway 130 that remain open, so that the negative pressure (e.g., air suction, etc.) in the airway 130 of the tube 102 has been diminished to a low-level suction. When pressure on the actuator 114 is released, the spring member 126 shown in FIG. 9 forces the actuator 114 away from the tube 102, causing the actuator 114 to rotate about hinge 112 and retracting the gate 116 out of the airway 130 and partially out of the slot 120, back to its second position shown in FIGS. 7 and 8.

As can be seen from the foregoing description, the disclosed embodiments provide several important advantages. First, the gate unit 110 enables a dentist to easily and effectively change from a high volume suction to a low volume suction by simply depressing the actuator 114 of the gate unit 110. Thus, by means of a single finger or thumb, while grasping the aspirator tip 100 with the same hand, a dentist may change the aspirator suction from high volume suction to low volume suction. This feature substantially increases the comfort and convenience of working with the patient, since it allows the patient to quickly close his/her lips so that the low-level suction can remove the remainder of debris, saliva and rinse water from the patient's mouth.

The disclosed embodiments eliminate the need for a dentist to go through the cumbersome procedure of switching between separate aspirator units. The present system also allows dental assistants to work more efficiently, lessens the time that a dentist has to wait during evacuation pauses, and reduces overall time spent on evacuation during dental procedures.

Another significant advantage of the disclosed embodiments is that, by making the tip easily disposable, the risk of contamination is eliminated. In prior mechanisms where suction regulation is carried out by the main evacuation unit—such as by using a recessed gate, a metal valve or a rubber portion—those elements remained part of the evacuation unit and had to be cleaned and disinfected after each use. In the present system, all contaminated elements may be discarded after each surgical procedure, saving considerable cost and time over prior systems.

In addition, the disclosed embodiments make it possible for a dentist to obtain a precise amount of low suction by simply depressing the tab all the way to the closed position. The structure of the gate unit has been precisely determined so that desirable amounts of low volume suction and high volume suction are provided without any guesswork by the dentist.

Another important advantage is that there are essentially no moving parts to wear out or be replaced. The only moving members of the aspirator tip 100 are the hinge 112, the actuator 114 and the gate 116 of the gate unit 110. In embodiments where the actuator tip 100 may be replaced for each patient for hygienic reasons, there is never any need to clean the aspirator tip 100 or replace a malfunctioning member.

In addition, there is no need for a dentist to replace an existing aspirator system to implement the disclosed embodiments. The disposable tip may be connected to currently existing high suction aspirator system to immediately provide both high volume suction and low volume suction as desired. For the most part, a separate conventional low volume suction unit is no longer needed.

In one embodiment, the entire disposable tip unit 100 may be made from plastic formed by extrusion or other means. As an alternative, one or more parts of the elements of the aspirator tip 100 may be made out of metal or other suitable types of materials. In addition, the shapes and sizes of various components shown in the above embodiments may be changed as desired without departing from the present invention. In addition, other forms of single finger or thumb actuation may be utilized to lower the gate 116 into the slot 120 in the tube 102. As an example, a button might replace the thumb tab, wherein the button may be depressed by a single digit (such as a finger or thumb) to electronically actuate lowering of the gate 116 into the slot 120 or raising of the gate 116 out of the slot 120.

Although the above embodiments are representative of the present invention, other embodiments will be apparent to those skilled in the art from a consideration of this specification and the appended claims, or from a practice of the embodiments of the disclosed invention. It is intended that the specification and embodiments therein be considered as examples only, with the present invention being defined by the claims and their equivalents.

What is claimed:

1. A tip apparatus for a dental aspirator comprising:
an elongated hollow tube comprising a first end and a second end, the first end adapted to connect to a dental aspirator unit to provide suction to the second end of the elongated hollow tube, the second end adapted to be inserted into an oral cavity of a patient,
an opening in a portion of the elongated hollow tube between the first end and the second end of the elongated hollow tube,
a gate configured to be inserted into the opening, and
an actuator adapted for actuation by a single digit to insert the gate into the opening to at least partially block an airway of the elongated hollow tube.

2. The tip apparatus of claim 1, whereby the gate when fully inserted into the opening substantially diminishes the amount of suction flowing through the elongated hollow tube by a predetermined amount of suction.

3. The tip apparatus of claim 1, wherein the gate is actuated by a digit of a person grasping the tip apparatus.

4. The tip apparatus of claim 1, wherein the actuator comprises a thumb tab on the gate adapted for depression to insert the gate into the opening.

5. The tip apparatus of claim 1, wherein the opening comprises a transverse slot in the elongated hollow tube.

6. The tip apparatus of claim 5, wherein the gate comprises a thin member adapted to be inserted into the transverse slot.

7. The tip apparatus of claim 1, wherein the gate is affixed to the elongated hollow tube by a living hinge.

8. The tip apparatus of claim 1, further comprising a guide element adjacent to the opening for guiding the gate into the opening.

9. The tip apparatus of claim 8, wherein the guide element extends vertically from the elongated hollow tube to align with the gate as it is inserted into the opening.

10. The tip apparatus of claim 1, wherein the entire tip apparatus is disposable after a dental procedure.

11. The tip apparatus of claim 1, further comprising a spring member associated with the gate and the actuator to bias the gate in an open position.

12. An apparatus for attaching to a high volume evacuator dental unit providing suction to the oral cavity of a dental patient, comprising:
a dental aspirator tip configured to be coupled to the high volume evacuator dental unit to apply suction to the oral cavity,
a gate unit configured to change the suction being applied to the oral cavity by a preselected amount, and
an actuator associated with the gate unit to actuate the change of the applied suction by a single digit of a person grasping the dental aspirator tip.

13. The apparatus of claim 12, wherein the dental aspirator tip comprises a disposable tip device.

14. The apparatus of claim 13, wherein the gate unit is affixed to the disposable tip device and comprises a blocking device having a first position where the suction applied to the oral cavity is not affected by the blocking device and a second position where the suction applied to the oral cavity is diminished by a predetermined amount by the blocking device.

15. The apparatus of claim 14, wherein the actuator comprises an actuator affixed to the disposable tip device for moving the blocking device from the first position to the second position.

16. The apparatus of claim 15, wherein the actuator comprises a pad element affixed to the blocking device to change the blocking device between the first position and the second position.

17. The apparatus of claim 16, further comprising a biasing element between the actuator and the blocking device to bias the blocking device to the first position when the actuator is not applied to the blocking device.

18. The apparatus of claim 17, further comprising a guide member to assist the blocking device in moving between the first and second positions.

19. A process for applying a variable suction dental device to the mouth of a patient by a dental aspirator tip connected to an aspirator device having a constant amount of suction, the process comprising partially blocking the suction being applied by the aspirator device to the dental aspirator tip by depressing an actuator using a single digit of a person grasping the dental aspirator tip.

20. The process of claim 19, further comprising restoring the suction being applied by the aspirator device to the dental aspirator tip by releasing the actuator using the single digit of the person grasping the dental aspirator tip.
